(19) United States
(12) Patent Application Publication
(10) Pub. No.: US 2022/0198158 A1
(43) Pub. Date: Jun. 23, 2022

(54) METHOD FOR TRANSLATING SUBTITLES, ELECTRONIC DEVICE, AND NON-TRANSITORY STORAGE MEDIUM

(71) Applicant: HON HAI PRECISION INDUSTRY CO., LTD., New Taipei (TW)

(72) Inventor: YUHG-CHANG TAI, New Taipei (TW)

(21) Appl. No.: 17/526,273

(22) Filed: Nov. 15, 2021

(30) Foreign Application Priority Data
Dec. 23, 2020 (CN) 202011541056.X

(51) Int. Cl. G06F 40/58; G06F 40/53; H04N 5/278

(52) U.S. Cl. CPC G06F 40/58; H04N 5/278; G06F 40/53

(57) ABSTRACT

A method for translating subtitles, an electronic device, and a non-transitory storage medium in the present disclosure acquire subtitle information. When there are the currency amount information in the subtitle information, a preset target currency category and a preset target language category are obtained, currency amount information in the subtitle information is converted into target currency amount information corresponding to the target currency category, and text information in the subtitle information is converted into target text information corresponding to the target language category. Updated subtitle information is obtained according to the target currency amount information and the target text information and the updated subtitle information is displayed. The currency amount information in the subtitle information is translated according to the user's needs to make it conform to the user's cultural background, assist users in understanding currency amounts, and improve the user's viewing experience.

### FIELD

The present disclosure relates to a technical field of multimedia technology, specifically a method for translating subtitles, an electronic device, and a non-transitory storage medium.

### BACKGROUND

Subtitles in images help users understand the content of the video. In the prior art, quantities and other concepts of the original texts are directly translated, which makes it difficult for users of a different cultural background to quickly understand the meaning of the quantities and other information in the subtitles.

### BRIEF DESCRIPTION OF THE DRAWINGS

FIG. 1 shows a flowchart of a method for translating subtitles in an embodiment of the present disclosure.

FIG. 2 shows a schematic structural diagram of a device for translating subtitles in an embodiment of the present disclosure.

FIG. 3 shows a schematic structural diagram of an electronic device provided in an embodiment of the present disclosure.

### DETAILED DESCRIPTION

The accompanying drawings combined with the detailed description illustrate the embodiments of the present disclosure hereinafter. It is noted that embodiments of the present disclosure and features of the embodiments can be combined, when there is no conflict.

Various details are described in the following descriptions for a better understanding of the present disclosure, however, the present disclosure may also be implemented in other ways other than those described herein. The scope of the present disclosure is not to be limited by the specific embodiments disclosed below.

Unless defined otherwise, all technical and scientific terms used herein have the same meaning as commonly understood by one of ordinary skill in the art to which the present disclosure belongs. The terms used herein in the present disclosure are only for the purpose of describing specific embodiments and are not intended to limit the present disclosure.

Optionally, the method for translating subtitles of the present disclosure is applied to one or more electronic devices. The electronic device includes hardware such as, but not limited to, a microprocessor and an Application Specific Integrated Circuit (ASIC), Field-Programmable Gate Array (FPGA), Digital Signal Processor (DSP), embedded devices, etc.

The electronic device may be a device such as a desktop computer, a notebook, a palmtop computer, or a cloud server. The electronic device can interact with users through a keyboard, a mouse, a remote control, a touch panel, or a speeches control device.

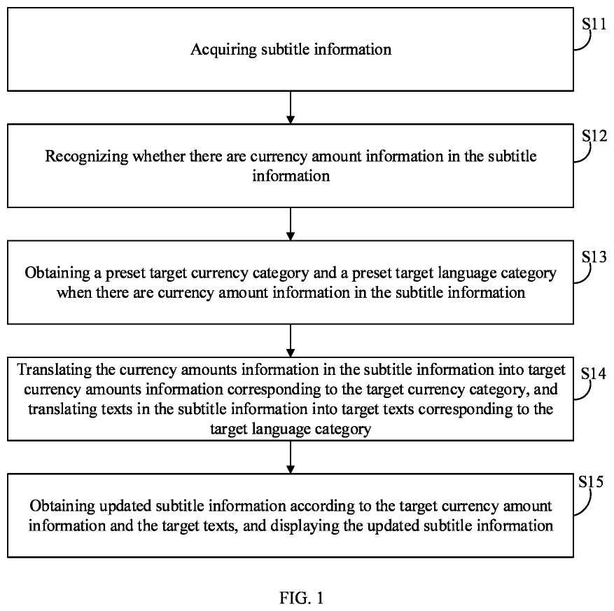

FIG. 1 is a flowchart of a method for translating subtitles in an embodiment of the present disclosure. The method for translating subtitles is applied to electronic devices. According to different needs, the order of the steps in the flowchart can be changed, and some can be omitted.

In block S11, acquiring subtitle information.

The subtitle information refer to non-video content such as dialogues displayed in written form in TV, movie, and stage works. It also refers to texts processed in the later stage of the film and TV works.

Translation of the subtitle information is required before the subtitles can be displayed. “Subtitle information” refers to information before translation which is to be displayed as subtitles.

In an embodiment, wherein acquiring subtitle information includes in response that input texts are received, converting the texts into speeches and obtaining the subtitle information in real time through the speeches.

In the above embodiment, a source of the subtitle information may be manually inputted pre-translation texts, and the inputted texts is used as the subtitle information; or, after the texts is converted into speeches through software, the subtitle information can be obtained in real time. The conversion of texts into speeches can be done by software such as, TTS (Texts-To-Speeches).

In another embodiment, wherein acquiring subtitle information includes in response that speaking speeches in the video are recorded, obtaining the subtitle information in the speaking speeches in real time.

In the above embodiment, the subtitle information may also be obtained through the speaking speeches in the video played by a user, wherein the user is a movie viewer.

By directly obtaining the subtitle information from the texts or obtaining the subtitle information from the speaking speeches, a flexibility of obtaining the subtitle information is improved.

In block S12, recognizing whether there are currency amount information in the subtitle information.

In the embodiment, the “currency amount information” include currency amounts, a currency identifier, and a currency category corresponding to the currency identifier. When the subtitle information is obtained, a recognition technology is used to recognize whether there are currency amount information in the subtitle information.

In block S13, obtaining a preset target currency category and a preset target language category when there are currency amount information in the subtitle information.

Before watching a movie or video, a user needs to set a currency category and a language category according to his preferred cultural background and needs in advance. When the currency amount information are recognized in the subtitle information, the currency category set by the user is acquired as the target currency category and the language category set by the user is acquired as the target language category.

Optionally, when there is no currency amount or similar information in the subtitle information, the method also includes displaying the subtitle information in a default display mode.

In block S14, translating the currency amounts information in the subtitle information into target currency amounts information corresponding to the target currency category, and translating texts in the subtitle information into target texts corresponding to the target language category.

The currency amounts information in the subtitle information are translated according to the target currency category. The texts in the subtitle information are translated according to the target language category.

In one embodiment, wherein translating the currency amounts information in the subtitle information into target currency amounts information corresponding to the target currency category includes recognizing a first currency identifier and a first currency amount; determining a first currency category corresponding to the first currency identifier; matching a second currency identifier corresponding to target currency category according to a preset currency conversion list; acquiring a rate of currency exchange between the first currency category and the target currency category; calculating the rate of currency exchange and the first currency amount to obtain a second currency amount; generating the target currency amount information according to the second currency amount and the second currency identifier.

The first currency category corresponding to the first currency identifier and the target currency category may be sent to an exchange rate conversion platform, and the exchange rate conversion platform obtains a real-time rate of currency exchange between the first currency category and the target currency category and returns the real-time rate of currency exchange. Or, the real-time rate of currency exchange between the first currency category and the target currency category can be obtained by calling an exchange rate query interface. After obtaining the second currency amount by calculating the rate of currency exchange and the first currency amount, updating the first currency amount in the currency amount information to the second currency amount, and updating the first currency identifier in the currency amount information to the second currency identifier, so that the target currency amount information can be generated and obtained according to the second currency amount and the second currency identifier.

In the above embodiment, by translating the currency amount information in the subtitle information into the target currency amount information corresponding to the target currency category set by the user, an efficiency of the user in understanding currency amounts in the subtitle information is improved.

In one embodiment, wherein translating texts in the subtitle information into target texts corresponding to the target language category includes searching for the target language category in a subtitle database; when the target language category is searched for in the subtitle database, translating the texts in the subtitle information into the target texts corresponding to the target language category; when the target language category is not searched for in the subtitle database, displaying a list of existing language categories for the user to select one language category; in response to a language category being selected by the user, converting the texts in the subtitle information into the target language category corresponding to the selected language category.

In a process of translating the texts in the subtitle information, and the target language type category is searched for in the subtitle database, when there is a language category that is the same as the target language category in the subtitle database, the texts in the subtitle information is directly converted into the target texts corresponding to the target language category. When there is no language category that is the same as the target language category in the subtitle database, the list of existing language categories is displayed, and the user may select one language category from the list of existing language categories. Such selected language category is taken as the target language category for translating the texts.

Exemplarily, if the subtitle information is “The price of our new car is $50,000”, the target language category preset by the user is Traditional Chinese, and the target currency category preset by the user is New Taiwan Dollar, then the translated texts is: “zhe tai xinche de jiage wei (TWD: 1503228.22)”.

In the above embodiment, when there is no language category that is the same as the target language category in the subtitle database, the existing language categories in the subtitle database are displayed for selection, which improves a diversity of viewers' choices.

Optionally, the method further includes converting a numerical value in the target currency amount information into Chinese characters; and\or performing a rounding (rounding up or rounding down) on the numerical value in the target currency amount information.

In some embodiments, wherein converting the numerical value in the target currency amount information into Chinese characters includes converting the numerical value into Chinese uppercase amount and updating the Chinese uppercase amount to the target currency amount information.

Exemplarily, if the target subtitle information is “The price of our new car is 1,500,000 New Taiwan Dollars”, the target currency amount information in the subtitle information is “1,500,000 New Taiwan Dollars”. The numerical value of 1,500,000 in the target currency amount information is extracted, the numerical value of 1,500,000 is converted to 150 million, and the 150 million is updated to the target currency amount information, the translated target subtitle information is “zhe tai xinche de jiage wei wei 150 wan Taiwan dollars”.

In some embodiments, wherein performing the rounding on the numerical value in the target currency amount information includes: acquiring rounding information of the target currency category, performing a numerical rounding on the numerical value in the target currency amount information to obtain a target numerical value according to the rounding information, and updating the target numerical value to the target currency amount information.

Exemplarily, suppose the target subtitle information is “The price of our new car is NT$1,503,228”, the target currency amount information is NT$1,503,228, and suppose the rounding information is to retain the first three numerical values, then the target numerical value of 1,503,228 in the target currency amount information will be rounded up to 1,500,000, and the 1,500,000 will be updated to the target currency amount information. The converted target subtitle information is “The price of our new car is NT$1,500,000.”

In the above embodiment, by performing the rounding on the numerical value in the target currency amount information, a secondary conversion of the currency amount information is realized, and the efficiency of the user in understanding the subtitle information and the currency amounts in the subtitle information is further improved.

In block S15, obtaining updated subtitle information according to the target currency amount information and the target texts, and displaying the updated subtitle information.

After translating the subtitle information, the updated subtitle information are obtained, and the updated subtitle information are displayed.

In some embodiments, the method further includes: acquiring preferences preset by the user and displaying the updated subtitle information according to the preferences.

The preferences can be preset, and the preset preferences include: displaying only the target currency amount information after conversion, displaying only the currency amount information before translation, or displaying both the target currency amount information after conversion and the currency amount information before translation.

Exemplarily, suppose the target language category is Traditional Chinese and the target currency category is New Taiwan dollar, the preference is to display only the target currency amount information after conversion, for example: the subtitle information before translation is: “The price of our new car is $50,000”, the final subtitle information are displayed as “zhe tai xinche de jiage wei 150 wan.”

For another example, suppose the target language category is Traditional Chinese and the target currency category is New Taiwan dollar, the preference is to display only the currency amount information before translation, for example: the subtitle information before translation is: “The price of new car is $50,000”, the final subtitle information displayed is “zhe tai xinche de jiage wei 5 wan meijin.”

For another example, suppose the target language category is Traditional Chinese and the target currency category is New Taiwan dollar, the preference is to display both the target currency amount information after conversion and the currency amount information before translation, for example: the subtitle information before translation is: “The price of new car is $50,000”, the final subtitle information displayed as “zhe tai xinche de jiage wei 5 wan meijin (150wan taibi).”

In the above embodiment, by displaying the currency amount information according to the user's preset preferences, it assists the user to understand the numerical value in the currency amount information, and further improves the user's efficiency in understanding the subtitle information and the currency amounts in the subtitle information.

The method for translating subtitles in the present disclosure acquires subtitle information and recognizes whether there is amount information in the subtitle information. When there is the currency amount information in the subtitle information, a preset target currency category and a preset target language category are obtained, amount information in the subtitle information is converted into target currency amount information corresponding to the target currency category, and texts in the subtitle information is converted into target texts corresponding to the target language category. Updated subtitle information is obtained according to the target currency amount information and the target texts, and display the updated subtitle information. On the one hand, the currency amount information in the subtitle information is dynamically converted according to the user's needs to make it conform to the user's cultural background, assist users in understanding the subtitle information, and improve the user's viewing experience. On the other hand, by optimizing the numerical value in the converted amount information, the efficiency of the user's understanding of the subtitle information and the currency amount information in the subtitle information is further improved.

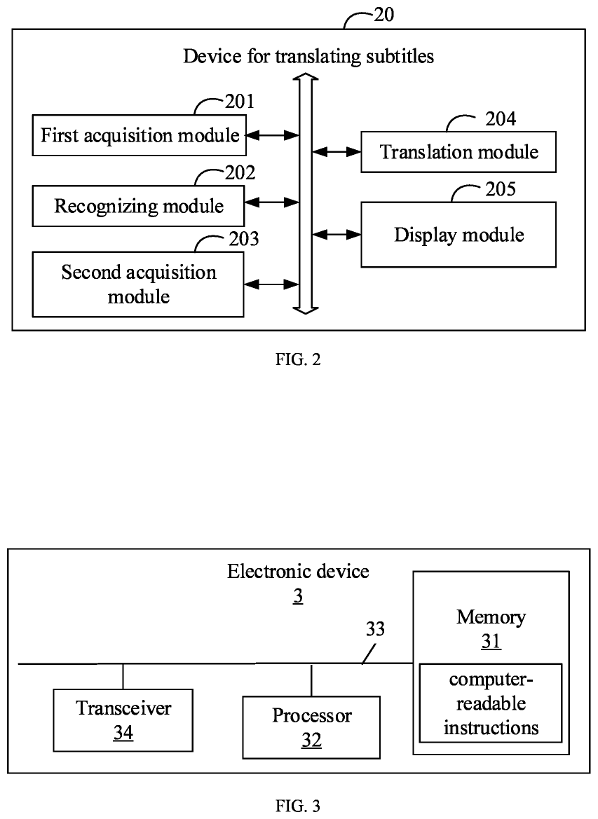

FIG. 2 shows a schematic structural diagram of a device for translating subtitles provided in the embodiment of the present disclosure.

In some embodiments, the device for translating subtitles 20 runs in an electronic device. The device for translating subtitles 20 can include a plurality of function modules consisting of program code segments. The program code of each program code segments in the device for translating subtitles 20 can be stored in a memory and executed by at least one processor to perform image processing (described in detail in FIG. 2).

As shown in FIG. 2, the device for translating subtitles 20 can include: a first acquisition module 201, an recognizing module 202, a second acquisition module 203, a translation module 204, and a display module 205. A module as referred to in the present disclosure refers to a series of computer-readable instruction segments that can be executed by at least one processor and that are capable of performing fixed functions, which are stored in a memory. In some embodiment, the functions of each module will be detailed.

The above-mentioned integrated unit implemented in a form of software functional modules can be stored in a non-transitory readable storage medium. The above software function modules are stored in a storage medium and includes several instructions for causing an electronic device (which can be a personal computer, a dual-screen device, or a network device) or a processor to execute the method described in various embodiments in the present disclosure.

The first acquisition module 201 acquires subtitle information.

The subtitle information refer to non-video content such as dialogues displayed in written form in TV, movie, and stage works. It also refers to texts processed in the later stage of the film and TV works.

Translation of the subtitle information is required before the subtitles can be displayed. “Subtitle information” refers to information before translation which is to be displayed as subtitles.

In an embodiment, the first acquisition module 201 acquiring subtitle information includes in response that input texts are received, converting the texts into speeches and obtaining the subtitle information in real time through the speeches.

In the above embodiment, a source of the subtitle information may be manually inputted pre-translation texts, and the inputted texts is used as the subtitle information; or, after the texts is converted into speeches through software, the subtitle information can be obtained in real time. The conversion of texts into speeches can be done by software such as, TTS (Texts-To-Speeches).

In another embodiment, the first acquisition module 201 acquiring subtitle information includes in response that speaking speeches in the video are recorded, obtaining the subtitle information in the speaking speeches in real time.

In the above embodiment, the subtitle information may also be obtained through the speaking speeches in the video played by a user, wherein the user is a movie viewer.

By directly obtaining the subtitle information from the texts or obtaining the subtitle information from the speaking speeches, a flexibility of obtaining the subtitle information is improved.

The recognizing module 202 recognizes there are currency amount information in the subtitle information.

In the embodiment, the “currency amount information” include currency amounts, a currency identifier, and a currency category corresponding to the currency identifier. When the subtitle information is obtained, a recognition technology is used to recognize whether there are currency amount information in the subtitle information.

The second acquisition module 203 obtains a preset target currency category and a preset target language category when there are currency amount information in the subtitle information.

Before watching a movie or video, a user needs to set a currency category and a language category according to his preferred cultural background and needs in advance. When the currency amount information are recognized in the subtitle information, the currency category set by the user is acquired as the target currency category and the language category set by the user is acquired as the target language category.

Optionally, when there is no currency amount or similar information in the subtitle information, the method also includes displaying the subtitle information in a default display mode.

The translation module 204 translates the currency amounts information in the subtitle information into target currency amounts information corresponding to the target currency category, and translates texts in the subtitle information into target texts corresponding to the target language category.

The currency amounts information in the subtitle information are translated according to the target currency category. The texts in the subtitle information are translated according to the target language category.

In one embodiment, the translation module 204 translating the currency amounts information in the subtitle information into target currency amounts information corresponding to the target currency category includes recognizing a first currency identifier and a first currency amount; determining a first currency category corresponding to the first currency identifier; matching a second currency identifier corresponding to target currency category according to a preset currency conversion list; acquiring a rate of currency exchange between the first currency category and the target currency category; calculating the rate of currency exchange and the first currency amount to obtain a second currency amount; generating the target currency amount information according to the second currency amount and the second currency identifier.

The first currency category corresponding to the first currency identifier and the target currency category may be sent to an exchange rate conversion platform, and the exchange rate conversion platform obtains a real-time rate of currency exchange between the first currency category and the target currency category and returns the real-time rate of currency exchange. Or, the real-time rate of currency exchange between the first currency category and the target currency category can be obtained by calling an exchange rate query interface. After obtaining the second currency amount by calculating the rate of currency exchange and the first currency amount, updating the first currency amount in the currency amount information to the second currency amount, and updating the first currency identifier in the currency amount information to the second currency identifier, so that the target currency amount information can be generated and obtained according to the second currency amount and the second currency identifier.

In the above embodiment, by translating the currency amount information in the subtitle information into the target currency amount information corresponding to the target currency category set by the user, an efficiency of the user in understanding the currency amounts in the subtitle information is improved.

In one embodiment, the translation module 204 translating texts in the subtitle information into target texts corresponding to the target language category includes searching for the target language category in a subtitle database; when the target language category is searched for in the subtitle database, translating the texts in the subtitle information into the target texts corresponding to the target language category; when the target language category is not searched for in the subtitle database, displaying a list of existing language categories for the user to select one language category; in response to a language category being selected by the user, converting the texts in the subtitle information into the target language category corresponding to the selected language category.

In a process of translating the texts in the subtitle information, and the target language type category is searched for in the subtitle database, when there is a language category that is the same as the target language category in the subtitle database, the texts in the subtitle information is directly converted into the target texts corresponding to the target language category. When there is no language category that is the same as the target language category in the subtitle database, the list of existing language categories is displayed, and the user may select one language category from the list of existing language categories. Such selected language category is taken as the target language category for translating the texts.

Exemplarily, if the subtitle information is “The price of our new car is $50,000”, the target language category preset by the user is Traditional Chinese, and the target currency category preset by the user is New Taiwan Dollar, then the translated texts is: “zhe tai xinche de jiage wei (TWD: 1503228.22)”.

In the above embodiment, when there is no language category that is the same as the target language category in the subtitle database, the existing language categories in the subtitle database are displayed for selection, which improves a diversity of viewers' choices.

Optionally, the translation module 204 further converts a numerical value in the target currency amount information into Chinese characters; and\or performs a rounding (rounding up or rounding down) on the numerical value in the target currency amount information.

In some embodiments, the translation module 204 converting the numerical value in the target currency amount information into Chinese characters includes converting the numerical value into Chinese uppercase amount and updating the Chinese uppercase amount to the target currency amount information.

Exemplarily, suppose the target subtitle information is “The price of our new car is NT$1,503,228”, the target currency amount information is NT$1,503,228, and suppose the rounding information is to retain the first three numerical values, then the target numerical value of 1,503,228 in the target currency amount information will be rounded up to 1,500,000, and the 1,500,000 will be updated to the target currency amount information. The converted target subtitle information is “The price of our new car is NT$1,500,000.”

In some embodiments, the translation module 204 performing the rounding on the numerical value in the target currency amount information includes: acquiring rounding information of the target currency category, performing a numerical rounding on the numerical value in the target currency amount information to obtain a target numerical value according to the rounding information, and updating the target numerical value to the target currency amount information.

Exemplarily, suppose the target subtitle information is “The price of our new car is NT$1,503,228”, the target currency amount information is NT$1,503,228, and suppose the rounding information is to retain the first three numerical values, then the target numerical value of 1,503,228 in the target currency amount information will be rounded up to 1,500,000, and the 1,500,000 will be updated to the target currency amount information. The converted target subtitle information is “The price of our new car is NT$1,500,000.”

In the above embodiment, by performing the rounding on the numerical value in the target currency amount information, a secondary conversion of the currency amount information is realized, and the efficiency of the user in understanding the subtitle information and the currency amounts in the subtitle information is further improved.

The display module 205 obtains updated subtitle information according to the target currency amount information and the target texts, and displays the updated subtitle information.

After translating the subtitle information, the updated subtitle information are obtained, and the updated subtitle information are displayed.

In some embodiments, the second acquisition module 203 further acquires preferences preset by the user and the display module 205 further displays the updated subtitle information according to the preferences.

The preferences can be preset, and the preset preferences include: displaying only the target currency amount information after conversion, displaying only the currency amount information before translation, or displaying both the target currency amount information after conversion and the currency amount information before translation.

Exemplarily, suppose the target language category is Traditional Chinese and the target currency category is New Taiwan dollar, the preference is to display only the target currency amount information after conversion, for example: the subtitle information before translation is: “The price of our new car is $50,000”, the final subtitle information are displayed as “zhe tai xinche de jiage wei 150 wan.”

For another example, suppose the target language category is Traditional Chinese and the target currency category is New Taiwan dollar, the preference is to display only the currency amount information before translation, for example: the subtitle information before translation is: “The price of new car is $50,000”, the final subtitle information displayed is “zhe tai xinche de jiage wei 5 wan meijin.”

For another example, suppose the target language category is Traditional Chinese and the target currency category is New Taiwan dollar, the preference is to display both the target currency amount information after conversion and the currency amount information before translation, for example: the subtitle information before translation is: “The price of new car is $50,000”, the final subtitle information displayed as “zhe tai xinche de jiage wei 5 wan meijin (150wan taibi).”

In the above embodiment, by displaying the currency amount information according to the user's preset preferences, it assists the user to understand the numerical value in the currency amount information, and further improves the user's efficiency in understanding the subtitle information and the currency amounts in the subtitle information.

The device for translating subtitles in the present disclosure acquires subtitle information and recognizes whether there is amount information in the subtitle information. When there is the currency amount information in the subtitle information, a preset target currency category and a preset target language category are obtained, amount information in the subtitle information is converted into target currency amount information corresponding to the target currency category, and texts in the subtitle information is converted into target texts corresponding to the target language category. Updated subtitle information is obtained according to the target currency amount information and the target texts, and display the updated subtitle information. On the one hand, the currency amount information in the subtitle information is dynamically converted according to the user's needs to make it conform to the user's cultural background, assist users in understanding the subtitle information, and improve the user's viewing experience. On the other hand, by optimizing the numerical value in the converted amount information, the efficiency of the user's understanding of the subtitle information and the currency amount information in the subtitle information is further improved.

The embodiment also provides a non-transitory readable storage medium having computer-readable instructions stored therein. The computer-readable instructions are executed by a processor to implement the steps in the above-mentioned method for translating subtitles, such as in steps in block S11-15 shown in FIG. 1:

In block S11, acquiring subtitle information;

In block S12, recognizing whether there are currency amount information in the subtitle information;

In block S13, obtaining a preset target currency category and a preset target language category when there are currency amount information in the subtitle information;

In block S14, translating the currency amounts information in the subtitle information into target currency amounts information corresponding to the target currency category, and translating texts in the subtitle information into target texts corresponding to the target language category;

In block S15, obtaining updated subtitle information according to the target currency amount information and the target texts, and displaying the updated subtitle information.

The computer-readable instructions are executed by the processor to realize the functions of each module/unit in the above-mentioned device embodiments, such as the modules 201-205 in FIG. 2:

The first acquisition module 201 acquires subtitle information;

The recognizing module 202 recognizes whether there are currency amount information in the subtitle information;

The second acquisition module 203 obtains a preset target currency category and a preset target language category when there are currency amount information in the subtitle information;

The translation module 204 translates the currency amounts information in the subtitle information into target currency amounts information corresponding to the target currency category, and translates texts in the subtitle information into target texts corresponding to the target language category;

The display module 205 obtains updated subtitle information according to the target currency amount information and the target texts, and displays the updated subtitle information.

FIG. 3 is a schematic structural diagram of an electronic device provided in an embodiment of the present disclosure. The electronic device 3 may include: a memory 31, at least one processor 32, and computer-readable instructions stored in the memory 31 and executable on the at least one processor 32, for example, subtitles translation programs, a transceiver 34, and a bus 33 connecting the memory 31, the at least one processor 32, and the transceiver 34. The processor 32 executes the computer-readable instructions to implement the steps in the embodiment of the method for translating subtitles, such as in steps S11-S15 shown in FIG. 1. Alternatively, the processor 32 executes the computer-readable instructions to implement the functions of the modules/units in the foregoing device embodiments, such as the modules 201-205 in FIG. 2.

For example, the computer-readable instructions can be divided into one or more modules/units, and the one or more modules/units are stored in the memory 31 and executed by the at least one processor 32. The one or more modules/units can be a series of computer-readable instruction segments capable of performing specific functions, and the instruction segments are used to describe execution processes of the computer-readable instructions in the electronic device 3. For example, the computer-readable instruction can be divided into the first acquisition module 201, the recognizing module 202, the second acquisition module 203, the translation module 204, and the display module 205 as in FIG. 2.

The electronic device 3 can be an electronic device such as a desktop computer, a notebook, a palmtop computer, and a cloud server. Those skilled in the art will understand that the schematic diagram 3 is only an example of the electronic device 3 and does not constitute a limitation on the electronic device 3. Another electronic device 3 may include more or fewer components than shown in the figures or may combine some components or have different components. For example, the electronic device 3 may further include an input/output device, a network access device, a bus, and the like.

The at least one processor 32 can be a central processing unit (CPU), or can be another general-purpose processor, digital signal processor (DSPs), application-specific integrated circuit (ASIC), Field-Programmable Gate Array (FPGA), another programmable logic device, discrete gate, transistor logic device, or discrete hardware component, etc. The processor 32 can be a microprocessor or any conventional processor. The processor 32 is a control center of the electronic device 3 and connects various parts of the entire electronic device 3 by using various interfaces and lines.

The memory 31 can be configured to store the computer-readable instructions and/or modules/units. The processor 32 may run or execute the computer-readable instructions and/or modules/units stored in the memory 31 and may call up data stored in the memory 31 to implement various functions of the electronic device 3. The memory 31 mainly includes a storage program area and a storage data area. The storage program area may store an operating system, and an application program required for at least one function (such as a sound playback function, an image playback function, etc.), etc. The storage data area may store data (such as audio data, phone book data, etc.) created according to the use of the electronic device 3. In addition, the memory 31 may include a high-speed random access memory, and may also include a non-transitory storage medium, such as a hard disk, an internal memory, a plug-in hard disk, a smart media card (SMC), a secure digital (SD) Card, a flashcard, at least one disk storage device, a flash memory device, or another non-transitory solid-state storage device.

When the modules/units integrated into the electronic device 3 are implemented in the form of software functional units having been sold or used as independent products, they can be stored in a non-transitory readable storage medium. Based on this understanding, all or part of the processes in the methods of the above embodiments implemented by the present disclosure can also be completed by related hardware instructed by computer-readable instructions. The computer-readable instructions can be stored in a non-transitory readable storage medium. The computer-readable instructions, when executed by the processor, may implement the steps of the foregoing method embodiments. The computer-readable instructions include computer-readable instruction codes, and the computer-readable instruction codes can be in a source code form, an object code form, an executable file, or some intermediate form. The non-transitory readable storage medium can include any entity or device capable of carrying the computer-readable instruction code, such as a recording medium, a U disk, a mobile hard disk, a magnetic disk, an optical disk, a computer memory, or a read-only memory (ROM).

In the several embodiments provided in the preset application, the disclosed electronic device and method can be implemented in other ways. For example, the embodiments of the devices described above are merely illustrative. For example, divisions of the units are only logical function divisions, and there can be other manners of division in actual implementation.

In addition, each functional unit in each embodiment of the present disclosure can be integrated into one processing unit, or can be physically present separately in each unit or two or more units can be integrated into one unit. The above modules can be implemented in a form of hardware or in a form of a software functional unit.

The present disclosure is not limited to the details of the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or device through software or hardware. Words such as “first” and “second” are used to indicate names, but not in any particular order.

Finally, the above embodiments are only used to illustrate technical solutions of the present disclosure and are not to be taken as restrictions on the technical solutions. Although the present disclosure has been described in detail with reference to the above embodiments, those skilled in the art should understand that the technical solutions described in one embodiment can be modified, or some of the technical features can be equivalently substituted, and that these modifications or substitutions are not to detract from the essence of the technical solutions or from the scope of the technical solutions of the embodiments of the present disclosure.

What is claimed is:

1. A method for translating subtitles, the method comprising:
acquiring subtitle information;
recognizing whether there are currency amount information in the subtitle information;
obtaining a preset target currency category and a preset target language category when there are currency amount information in the subtitle information;
translating the currency amounts information in the subtitle information into target currency amounts information corresponding to the target currency category, and translating texts in the subtitle information into target texts corresponding to the target language category; and
obtaining updated subtitle information according to the target currency amount information and the target texts, and displaying the updated subtitle information.

2. The method for translating subtitles of claim 1, the method further comprising:
converting a numerical value in the target currency amount information into Chinese characters, after translating the currency amounts information in the subtitle information into target currency amounts information corresponding to the target currency category; and
performing a rounding on the numerical value in the target currency amount information.

3. The method for translating subtitles of claim 1, the method further comprising:
acquiring preferences preset by a user; and
displaying the updated subtitle information according to the preferences.

4. The method for translating subtitles of claim 1, wherein translating the currency amounts information in the subtitle information into target currency amounts information corresponding to the target currency category comprises:
recognizing a first currency identifier and a first currency amount;
determining a first currency category corresponding to the first currency identifier;
matching a second currency identifier corresponding to target currency category according to a preset currency conversion list;
acquiring a rate of currency exchange between the first currency category and the target currency category;
calculating the rate of currency exchange and the first currency amount to obtain a second currency amount; and
generating the target currency amount information according to the second currency amount and the second currency identifier.

5. The method for translating subtitles of claim 1, wherein acquiring subtitle information comprises:
in response that input texts are received, converting the texts into speeches and obtaining the subtitle information in real time through the speeches.

6. The method for translating subtitles of claim 1, wherein acquiring subtitle information comprises:
in response that speaking speeches in the video are recorded, obtaining the subtitle information in the speaking speeches in real time.

7. The method for translating subtitles of claim 1, wherein translating texts in the subtitle information into target texts corresponding to the target language category comprises:
searching for the target language category in a subtitle database;
when the target language category is searched for in the subtitle database, translating the texts in the subtitle information into the target texts corresponding to the target language category;
when the target language category is not searched for in the subtitle database, displaying a list of existing language categories for the user to select one language category; and in response to a language category being selected by the user, converting the texts in the subtitle information into the target language category corresponding to the selected language category.

8. An electronic device comprising a memory and a processor, the memory stores at least one computer-readable instruction, which when executed by the processor causes the processor to:
acquire subtitle information;
recognize whether there are currency amount information in the subtitle information;
obtain a preset target currency category and a preset target language category when there are currency amount information in the subtitle information;
translate the currency amounts information in the subtitle information into target currency amounts information corresponding to the target currency category, and translate texts in the subtitle information into target texts corresponding to the target language category; and
obtain updated subtitle information according to the target currency amount information and the target texts, and display the updated subtitle information.

9. The electronic device of claim 8, wherein the processor is further caused to:
convert a numerical value in the target currency amount information into Chinese characters, after translating the currency amounts information in the subtitle information into target currency amounts information corresponding to the target currency category; and
perform a rounding on the numerical value in the target currency amount information.

10. The electronic device of claim 8, wherein the processor is further caused to:
acquire preferences preset by a user; and
display the updated subtitle information according to the preferences.

11. The electronic device of claim 8, wherein the processor translates the currency amounts information in the subtitle information into target currency amounts information corresponding to the target currency category by:
recognizing a first currency identifier and a first currency amount;
determining a first currency category corresponding to the first currency identifier;
matching a second currency identifier corresponding to target currency category according to a preset currency conversion list;
acquiring a rate of currency exchange between the first currency category and the target currency category;
calculating the rate of currency exchange and the first currency amount to obtain a second currency amount; and
generating the target currency amount information according to the second currency amount and the second currency identifier.

12. The electronic device of claim 8, wherein the processor acquires subtitle information by:
in response that input texts are received, converting the texts into speeches and obtaining the subtitle information in real time through the speeches.

13. The electronic device of claim 8, wherein the processor acquires subtitle information by:
in response that speaking speeches in the video are recorded, obtaining the subtitle information in the speaking speeches in real time.

14. The electronic device of claim 8, wherein the processor translates texts in the subtitle information into target texts corresponding to the target language category by:
searching for the target language category in a subtitle database;
when the target language category is searched for in the subtitle database, translating the texts in the subtitle information into the target texts corresponding to the target language category;
when the target language category is not searched for in the subtitle database, displaying a list of existing language categories for the user to select one language category; and in response to a language category being selected by the user, converting the texts in the subtitle information into the target language category corresponding to the selected language category.

15. A non-transitory storage medium having stored thereon at least one computer-readable instructions that, when the at least one computer-readable instructions are executed by a processor to implement a method for translating subtitles, which comprises:
acquiring subtitle information;
recognizing whether there are currency amount information in the subtitle information;
obtaining a preset target currency category and a preset target language category when there are currency amount information in the subtitle information;
translating the currency amounts information in the subtitle information into target currency amounts information corresponding to the target currency category, and translating texts in the subtitle information into target texts corresponding to the target language category; and
obtaining updated subtitle information according to the target currency amount information and the target texts, and displaying the updated subtitle information.

16. The non-transitory storage medium of claim 15, the method further comprising:
converting a numerical value in the target currency amount information into Chinese characters, after translating the currency amounts information in the subtitle information into target currency amounts information corresponding to the target currency category; and
performing a rounding on the numerical value in the target currency amount information.

17. The non-transitory storage medium of claim 15, the method further comprising:
acquiring preferences preset by a user; and
displaying the updated subtitle information according to the preferences.

18. The non-transitory storage medium of claim 15, wherein translating the currency amounts information in the subtitle information into target currency amounts information corresponding to the target currency category comprises:
recognizing a first currency identifier and a first currency amount;
determining a first currency category corresponding to the first currency identifier;
matching a second currency identifier corresponding to target currency category according to a preset currency conversion list;
acquiring a rate of currency exchange between the first currency category and the target currency category;
calculating the rate of currency exchange and the first currency amount to obtain a second currency amount; and
generating the target currency amount information according to the second currency amount and the second currency identifier.

19. The non-transitory storage medium of claim 15, wherein acquiring subtitle information comprises:
in response that input texts are received, converting the texts into speeches and obtaining the subtitle information in real time through the speeches; and
in response that speaking speeches in the video are recorded, obtaining the subtitle information in the speaking speeches in real time.

20. The non-transitory storage medium of claim 15, wherein translating texts in the subtitle information into target texts corresponding to the target language category comprises:
searching for the target language category in a subtitle database;
when the target language category is searched for in the subtitle database, translating the texts in the subtitle information into the target texts corresponding to the target language category;
when the target language category is not searched for in the subtitle database, displaying a list of existing language categories for the user to select one language category; and in response to a language category being selected by the user, converting the texts in the subtitle information into the target language category corresponding to the selected language category.
